(19) United States
(12) Patent Application Publication
(10) Pub. No.: US 2026/0046971 A1
(43) Pub. Date: Feb. 12, 2026

(54) MANAGING INACTIVITY FOR MULTICAST UE FOR NR-MBS IN WIRELESS NETWORK

(71) Applicant: Samsung Electronics Co., Ltd., Suwon-si, Gyeonggi-do (KR)

(72) Inventors: Vinay Kumar SHRIVASTAVA, Bangalore (IN); Aby Kanneath ABRAHAM, Bangalore (IN); Sriganesh RAJENDRAN, Bangalore (IN)

(21) Appl. No.: 18/997,656

(22) PCT Filed: Jul. 31, 2023
(86) PCT No.: PCT/KR2023/011157

§ 371 Date: Jan. 22, 2025

(30) Foreign Application Priority Data
Jul. 29, 2022 (IN) 202241043622
Jun. 28, 2023 (IN) 2022 41043622

(51) Int. Cl. H04W 76/27; H04W 76/40

(52) U.S. Cl. CPC H04W 76/27; H04W 76/40

(57) ABSTRACT

The disclosure relates to a 5G or 6G communication system for supporting a higher data transmission rate. Embodiments herein provide methods for managing inactivity for multicast UE (100) for NR-MBS in wireless network (1000) by UE (100). The method includes monitoring, based on a multicast-inactivity timer configuration, whether the UE receives in a RRC inactive state at least one of multicast data and a group notification or a group paging message indicating “activation” or “deactivation” of multicast session. In an embodiment, the method includes starting a multicast-inactivity timer or restarting a multicast-inactivity timer in the RRC inactive state when the UE receives at least one of the multicast data and the group notification or the group paging message indicating “activation” of the multicast session.

### CROSS-REFERENCE TO RELATED APPLICATION(S)

This application is a U.S. National Stage application under 35 U.S.C. § 371 of an International application number PCT/KR2023/011157, filed on Jul. 31, 2023, which is based on and claims priority of an Indian Provisional patent application number 202241043622, filed on Jul. 29, 2022, in the Indian Intellectual Property Office, and of an Indian Complete patent application number 202241043622, filed on Jun. 28, 2023, in the Indian Intellectual Property Office, the disclosure of each of which is incorporated by reference herein in its entirety.

### TECHNICAL FIELD

The present disclosure relates to wireless communication, and more specifically related to a User Equipment (UE) and a method for managing inactivity for the UEs for New Radio Multicast Broadcast Service (NR-MBS) in a wireless network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In general, NR-MBS services can refer to multicast services where intended common contents are targeted to a group of UEs that have joined in a multicast group in a multicast coverage area and broadcast services where intended contents may be targeted to all the UEs in a broadcast coverage area. The coverage area can be one radio cell or larger.

Unicast services can only be availed in a RRC_CONNECTED state. To track inactivity of the UEs, the UEs can be configured with a data-InactivityTimer timer through a RRC reconfiguration message. In a legacy system (i.e. 3^{rd} Generation Partnership Project (3GPP) Release 17 MBS), the UEs could receive multicast services only in the RRC_CONNECTED state. Therefore, data-InactivityTimer, if configured, can also track inactivity for both unicast and multicast in the RRC_CONNECTED state. However, there may be a new scenario that the UEs can receive multicast session(s) in a RRC_INACTIVE state (e.g. 3GPP Release 18 MBS may consider such a scenario). It is, therefore, needed to specify the approach for managing inactivity for such multicast UEs in the RRC_INACTIVE state.

A potential issue relates to the UEs for which the multicast session is being received in the RRC_INACTIVE state. It is possible that there may be inactivity i.e. the UE does not receive a multicast packet for a certain duration. In case if there is some signalling or notification from a network side to inform the UE in the RRC_INACTIVE state about inactivity and/or deactivation and/or suspension of the multicast session, possibly the UE may miss to receive such signalling or notification. In an example, the UE may be temporarily go out of coverage or is involved in multiple SIMs (MUSIM) operation. In fact, there is no such signalling or notification exists in the legacy system that informs the UE. The UE may continuously and indefinitely wait for the multicast packet and/or monitor for group notification/group paging. The UE may unnecessarily be expecting multicast packets and/or consuming power and/or continue in the RRC INACITVE state with no real reason. Therefore, there is a need to define a behavior for the multicast UE to manage inactivity in the RRC_INACTIVE state.

Thus, it is desired to address the above-mentioned disadvantages or other shortcomings or at least provide a useful alternative for managing inactivity for the UEs for the NR-MBS.

### DISCLOSURE

### Technical Problem

The principal object of the embodiments herein is to provide a method and a UE for managing inactivity for a UE for a NR-MBS in a wireless network.

Another object of the embodiments herein is to handle an inactivity of the UE to receive multicast in a RRC_INACTIVE state and ensures reliable and efficient multicast reception performance.

Another object of the embodiments herein is to monitor, based on a multicast-inactivity timer configuration, whether the UE receives in the RRC inactive state at least one of multicast data and a group notification or a group paging message indicating “activation” or “deactivation” of the multicast session

Another object of the embodiments herein is to start a multicast-inactivity timer or restarting a multicast-inactivity timer in the RRC inactive state when the UE receives at least one of the multicast data and the group notification or the group paging message indicating “activation” of the multicast session

Another object of the embodiments herein is to stop a multicast-inactivity timer or resetting a multicast-inactivity timer in the RRC inactive state when the UE receives at least one of the group notification or the group paging message indicating “deactivation”of the multicast session.

Another object of the embodiments herein is to transition the UE from the RRC inactive state to an RRC idle state when the UE does not receives at least one of the multicast data, the group notification, and the group paging message.

Another object of the embodiments herein is to transition the UE from the RRC inactive state to a RRC connected state upon expiry of the multicast-inactivity timer.

Another object of the embodiments herein is to trigger an initiation of a RRC connection resume upon validating congestion status of the network apparatus using a broadcast signalling message.

### Technical Solution

Accordingly, embodiments herein disclose a method for managing inactivity for multicast UE for a NR-MBS in a wireless network. The method includes receiving, by the UE, a multicast-inactivity timer configuration by a network apparatus for the multicast session reception in a RRC inactive state. Further, the method includes detecting, by the UE, that the UE is transitioned from the RRC connected state to a RRC inactive state. Further, the method includes monitoring, by the UE, based on the multicast-inactivity timer configuration whether the UE receives in the RRC inactive state at least one of multicast data and a group notification or a group paging message indicating “activation” or “deactivation” of the multicast session. In an embodiment, the method includes starting a multicast-inactivity timer or restarting a multicast-inactivity timer in the RRC inactive state when the UE receives at least one of the multicast data and the group notification or the group paging message indicating “activation” of the multicast session. In another embodiment, the method includes stopping a multicast-inactivity timer or resetting a multicast-inactivity timer in the RRC inactive state when the UE receives at least one of the group notification or the group paging message indicating “deactivation” of the multicast session. In another embodiment, the method includes transitioning the UE from the RRC inactive state to an RRC idle state when the UE does not receives at least one of the multicast data, the group notification, and the group paging message. In another embodiment, the method includes transitioning the UE from the RRC inactive state to a RRC connected state upon expiry of the multicast-inactivity timer. In another embodiment, the method includes triggering an initiation of a RRC connection resume upon validating congestion status of the network apparatus using a broadcast signalling message.

In an embodiment, transitioning the UE from the RRC inactive state to the RRC idle state includes detecting, by the UE, that the multicast-inactivity timer is running, determining, by the UE, whether the multicast-inactivity timer is expired, and performing, by the UE, one of: sending an indication from a lower layer of the UE to an upper layer of the UE indicating expiry of the multicast-inactivity timer, and transitioning the UE from the RRC inactive state to the RRC idle state when the multicast-inactivity timer is expired, continue monitoring by the UE whether the multicast data is received by the UE in the RRC inactive state.

In an embodiment, the UE transitions from the RRC inactive state to the RRC idle state when no activated multicast MBS radio bearer (MRB) configuration is available for the UE.

In an embodiment, upon receiving the indication, the method includes sending by the UE, a request from the upper layer to the lower layer to stop monitoring of the group notification or the group paging message. Further, the method includes stopping, by the UE, the multicast-inactivity timer. Further, the method includes releasing, by the UE, the multicast-inactivity timer configuration.

In an embodiment, transitioning the UE from the RRC inactive state to the RRC idle state includes receiving, by the UE, an indication from the network apparatus when the UE is in the RRC inactive state thorough at least one of a dedicated signaling message, a system information block (SIB) message or a MCCH message; and at least one of: transitioning the UE from the RRC inactive state to the RRC idle state when the indication is to transition to the RRC idle state on expiry of the multicast-inactivity timer, transitioning the UE from the RRC inactive state to the RRC connected state when the indication is to transition to the RRC connected state on expiry of the multicast-inactivity timer, and maintaining the UE in the RRC inactive state when the indication is to continue to stay in the RRC inactive state on expiry of the multicast-inactivity timer.

In an embodiment, determining, by the UE, whether the multicast data is received by the UE based on the multicast-inactivity timer in the RRC inactive state configuration includes storing, by the UE, a data-Inactivity timer configuration while transitioning from the RRC connected state to the RRC inactive state or the RRC idle state when the UE is configured to receive or continue receiving the multicast data in the RRC inactive state, and reusing by the UE the data-Inactivity timer configuration of the RRC connected state for the multicast-inactivity timer configuration to be used for the multicast UE to receive the multicast data in the RRC inactive state.

In an embodiment, the method includes determining, by the UE, a connection loss while receiving the multicast data in the RRC inactive state. Further, the method includes sending, by the UE, a RRC connection resume request to the network apparatus. Further, the method includes sending, by the UE, a multicast session release request to the network apparatus;

In an embodiment, the method includes determining, by the UE, a loss of interest in receiving the multicast session in the RRC inactive state. Further, the method includes sending, by the UE, a RRC connection resume request to the network apparatus. Further, the method includes sending, by the UE, a multicast session release request to the network apparatus;

In an embodiment, the multicast-inactivity timer configuration is received in one of a RRC Reconfiguration message, a RRC Release with suspend configuration message, and a System Information Block (SIB) message or MBS control Channel (MCCH) message.

In an embodiment, the multicast-inactivity timer configuration is at least one of pre-specified, pre-configured and a part of reduced configuration that is applicable to the UE for multicast reception in the inactive state.

In an embodiment, the multicast data corresponds to a MAC SDU for at least one multicast session on PTM multicast MBS traffic channel (MTCH) logical channel.

In an embodiment, the multicast-inactivity timer is started or restarted for each multicast packet of the multicast data received from the network apparatus.

In an embodiment, the method includes receiving, by the UE, one of a RRCSetup message and a RRCResume message from the network apparatus in response to one of a RRCReestablishmentRequest or a RRCResumeRequest or a RRCResumeRequest1 message sent by the UE. Further, the method includes performing, by the UE, at least one of: stopping or resetting the multicast-inactivityTimer, and releasing a multicast-inactivityTimer configuration.

In an embodiment, the method includes receiving, by the UE, a RRCReject message from the network apparatus in response to one of a RRCResumeRequest or a RRCResumeRequest1 message sent by the UE. Further, the method includes performing, by the UE, at least one of: continuing the multicast-inactivityTimer, and maintaining the multicast-inactivityTimer configuration

In an embodiment, the UE continues to receive the multicast session in time-duration in between events when the UE initiates sending of a RRCResumeRequest or RRCResumeRequest1 message to the network apparatus when the UE receives one of RRCResume or RRCSetup message from the network apparatus.

Accordingly, embodiments herein disclose a UE for managing inactivity for multicast UE for a NR-MBS in a wireless network. The UE includes a UE inactivity controller communicatively coupled to a memory and a processor. The UE inactivity controller is configured to receive a multicast-inactivity timer configuration by a network apparatus for the multicast session reception in a RRC inactive state. Further, the UE inactivity controller is configured to detect that the UE is transitioned from the RRC connected state to a RRC inactive state. Further, the UE inactivity controller is configured to monitor based on the multicast-inactivity timer configuration whether the UE receives in the RRC inactive state at least one of multicast data and a group notification or a group paging message indicating “activation” or “deactivation” of the multicast session. In an embodiment, the UE inactivity controller is configured to start a multicast-inactivity timer or restart a multicast-inactivity timer in the RRC inactive state when the UE receives at least one of the multicast data and the group notification or the group paging message indicating “activation” of the multicast session. In another embodiment, the UE inactivity controller is configured to stop a multicast-inactivity timer or reset a multicast-inactivity timer in the RRC inactive state when the UE receives at least one of the group notification or the group paging message indicating “deactivation” of the multicast session. In another embodiment, the UE inactivity controller is configured to transition the UE from the RRC inactive state to an RRC idle state when the UE does not receives at least one of the multicast data, the group notification, and the group paging message. In another embodiment, the UE inactivity controller is configured to transition the UE from the RRC inactive state to a RRC connected state upon expiry of the multicast-inactivity timer. In another embodiment, the UE inactivity controller is configured to trigger an initiation of a RRC connection resume upon validating congestion status of the network apparatus using a broadcast signalling message.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein, and the embodiments herein include all such modifications.

### Advantageous Effects

The embodiments herein is to provide a method and a UE for managing inactivity for a UE for a NR-MBS in a wireless network.

The embodiments herein is to handle an inactivity of the UE to receive multicast in a RRC_INACTIVE state and ensures reliable and efficient multicast reception performance.

### DESCRIPTION OF DRAWINGS

The invention is illustrated in the accompanying drawings, throughout which like reference letters indicate corresponding parts in the various figures. The embodiments herein will be better understood from the following description with reference to the drawings, in which:

FIG. 1 illustrates an overview of a wireless network for managing an inactivity for a UE for a NR-MBS, according to the embodiments as disclosed herein;

FIG. 2 shows various hardware components of the UE, according to the embodiments as disclosed herein;

FIG. 3 is a flow chart illustrating a method for managing the inactivity for the UE for the NR-MBS in the wireless network, according to the embodiments as disclosed herein; and

FIG. 4 illustrates an example flow chart to configuring and operating a multicast inactivity timer for the multicast UEs configured and/or capable of receiving multicast sessions in a RRC_INACTIVE state and/or receiving multicast sessions in the RRC_INACTIVE state, according to the embodiments as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, embodiments herein disclose a method for managing inactivity for multicast UE for a NR-MBS in a wireless network. The method includes receiving, by the UE, a multicast-inactivity timer configuration by a network apparatus for the multicast session reception in a RRC inactive state. Further, the method includes detecting, by the UE, that the UE is transitioned from the RRC connected state to a RRC inactive state. Further, the method includes monitoring, by the UE, based on the multicast-inactivity timer configuration whether the UE receives in the RRC inactive state at least one of multicast data and a group notification or a group paging message indicating “activation” or “deactivation” of the multicast session (for example, group notification may be provided by a MCCH message and group paging may be provided by a paging message). In an embodiment, the method includes starting a multicast-inactivity timer or restarting a multicast-inactivity timer in the RRC inactive state when the UE receives at least one of the multicast data and the group notification or the group paging message indicating “activation” of the multicast session. In another embodiment, the method includes stopping a multicast-inactivity timer or resetting a multicast-inactivity timer in the RRC inactive state when the UE receives at least one of the group notification or the group paging message indicating “deactivation” of the multicast session. In another embodiment, the method includes transitioning the UE from the RRC inactive state to an RRC idle state when the UE does not receives at least one of the multicast data, the group notification, and the group paging message. In another embodiment, the method includes transitioning the UE from the RRC inactive state to a RRC connected state upon expiry of the multicast-inactivity timer. In another embodiment, the method includes triggering an initiation of a RRC connection resume upon validating congestion status of the network apparatus using a broadcast signalling message.

The method can be used for configuring and operating the multicast inactivity timer for the UEs configured and/or capable of receiving multicast sessions in the RRC_INACTIVE state and/or receiving multicast sessions in the RRC_INACTIVE state, so as to ensure reliable and efficient multicast reception performance.

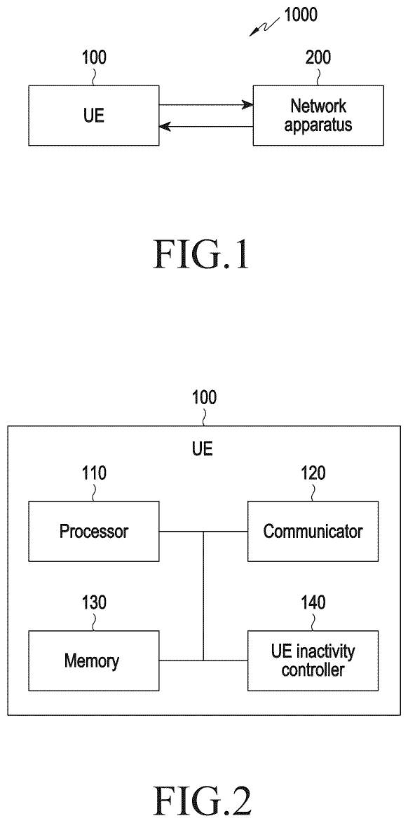

Referring now to the drawings, and more particularly to FIGS. 1 through 4, there are shown preferred embodiments.

FIG. 1 illustrates an overview of a wireless network (1000) for managing the inactivity for a UE (100) for a NR-MBS, according to the embodiments as disclosed herein. The wireless network (1000) can be, for example, but not limited to a fourth generation (4G) network, a fifth generation (5G) network, a sixth generation (6G) network, an Open Radio Access Network (ORAN) or the like. In an embodiment, the wireless network (1000) includes the UE (100) and a network apparatus (200).

The UE (100) can be, for example, but not limited to a laptop, a smart phone, a desktop computer, a notebook, a Device-to-Device (D2D) device, a vehicle to everything (V2X) device, a foldable phone, a smart TV, a tablet, a television, an immersive device, and an internet of things (IoT) device. The network apparatus (200) can be, for example, but not limited to a gNB, a eNB, a new radio (NR) trans-receiver or the like.

The UE (100) receives a multicast-inactivity timer configuration by the network apparatus (200) for the multicast session reception in a RRC inactive state. Further, the UE (100) detects that the UE (100) is transitioned from the RRC connected state to a RRC inactive state. Further, the UE (100) monitors based on the multicast-inactivity timer configuration whether the UE (100) receives in the RRC inactive state at least one of multicast data and a group notification or a group paging message indicating “activation” or “deactivation” of the multicast session. In an embodiment, the UE (100) starts a multicast-inactivity timer or restarts a multicast-inactivity timer in the RRC inactive state when the UE (100) receives at least one of the multicast data and the group notification or group paging message indicating “activation” of the multicast session. In another embodiment, the UE (100) stops a multicast-inactivity timer or resets a multicast-inactivity timer in the RRC inactive state when the UE (100) receives at least one of the group notification or the group paging message indicating “deactivation” of the multicast session. In another embodiment, the UE (100) transitions the UE (100) from the RRC inactive state to an RRC idle state when the UE (100) does not receives at least one of the multicast data, the group notification, and the group paging message. In another embodiment, the UE (100) transitions the UE (100) from the RRC inactive state to a RRC connected state upon expiry of the multicast-inactivity timer. In another embodiment, the UE (100) triggers an initiation of a RRC connection resume upon validating congestion status of the network apparatus (200) using a broadcast signalling message.

In an embodiment, the proposed method provides various techniques to configure the multicast inactivity timer (i.e. multicast-inactivityTimer) and handle the inactivity for the UEs (100) which are capable and/or configured to receive multicast in the RRC_INACTIVE state and/or receiving multicast session in the RRC_INACTIVE state. Particularly, the UEs (100) which are supporting 3GPP Release 18 MBS may be capable and/or configured to receive the multicast in the RRC_INACTIVE state and/or receiving multicast session in the RRC_INACTIVE state, whereas the UEs (100) pertaining to previous release (i.e. 3GPP Release 17 MBS) may not be capable and/or not configured to receive multicast in the RRC_INACTIVE state and cannot receive multicast session in RRC_INACTIVE state. Co-existence of these two sets of UEs (100) in the same cell/network is feasible and needs to be supported.

In an embodiment, configuration for the multicast-inactivityTimer for the UEs (100) that can receive the multicast session in a RRC_INACTIVE state is provided by the network apparatus (200). The configuration can be signalled through a RRC signalling that may include but is not limited to a RRC Reconfiguration message and/or a RRC Release with suspend configuration message. In an embodiment, the configuration of the multicast-inactivityTimer may be signalled in a System Information Block (SIB) or a MBS control Channel (MCCH), for example multicast MCCH message. The multicast-inactivityTimer configuration can also be at least one of pre-specified, pre-configured and part of reduced configuration that is applicable to the UE (100) for multicast reception in the RRC_INACTIVE state. Though, the configuration for the multicast-inactivityTimer can be received in the RRC_CONNECTED state, the multicast-inactivityTimer is operated (e.g. started and running) only when the multicast UE (100) transits to the RRC_INACTIVE state and is receiving the multicast session. That is, the multicast session is in “activated state” in the RRC_INACTIVE. When the multicast session is in “non-activated state” in the RRC_INACTIVE, the multicast-inactivityTimer is not required to be operated (i.e. not started or not running).

In an embodiment, a data-InactivityTimer configuration of the RRC_CONNECTED state is reused for the multicast-inactivityTimer configuration to be used for the multicast UE (100) to receive multicast session in the RRC_INACTIVE state. That is, the UE (100) preserve or store the data-InactivityTimer configuration while transitioning from the RRC_CONNECTED to a RRC_IDLE when the UE (100) is configured to receive or continue receiving multicast session in the RRC_INACTIVE. Further, when the UE (100) is configured with data-InactivityTimer configuration that is reused in the RRC_INACTIVE state and/or a separate multicast-inactivityTimer configuration to be used in the RRC_INACTIVE state, the UE (100) operation is as described further. In an embodiment, when there are multiple MRBs configured, a separate multicast-inactivityTimer may be configured and operated for each MRB.

If the UE (100) is in the RRC_INACTIVE state and is having at least one activated multicast session, if any medium access control (MAC) entity of the UE (100) (which is/are operating the multicast session(s)) receives a MAC SDU for the multicast MTCH logical channel, the UE (100) starts or restarts the multicast-inactivityTimer (or data-InactivityTimer). If multicast-inactivityTimer (or data-InactivityTimer) expires, the UE (100) informs to an upper layer (e.g. RRC layer). The RRC layer on getting the indication, transitions the UE (100) from the RRC_INACTIVE state to the RRC_IDLE state. In an embodiment, the UE (100) transitions from the RRC_INACTIVE state to the RRC_IDLE state on expiry of multicast-inactivityTimer (or data-Inactivity timer) when there is no activated MBS multicast radio bearer configuration available for the UE (100). In an embodiment, the network apparatus (200) (e.g., gNB or the like) configures the UE (100) whether to transition to the RRC_IDLE when data-inactivity timer expires. In an embodiment, the network apparatus (200) configures the UE (100) whether to continue to stay in the RRC_INACTIVE when data-inactivity timer expires. In an embodiment, the network apparatus (200) configures the UE (100) whether to transition to the RRC_CONNECTED when the data-inactivity timer expires. In an embodiment, the UE (100) transitions from the RRC_INACTIVE state to the RRC_CONNECTED state on expiry of the multicast-inactivityTimer (or data-Inactivity timer) e.g. the UE (100) initiates a RRC connection resume request for indicating a release of the at least one multicast session and/or the UE (100) initiates a RRC connection resume request for availing the at least one multicast session in an unicast mode or a Point-to-Point (PTP) delivery mode. In an embodiment, initiation for RRC connection Resume is triggered only after validating congestion status of the network apparatus (200) as indicated in broadcast signalling like SIB or MCCH or Group paging.

In an embodiment, when the UE (100) loses interest in multicast session reception while in the RRC_INACTIVE state and the multicast session may be in activated state or non-activated state (i.e. deactivated state), to formally release the multicast session, the UE (100) can initiate a RRC connection resume request and convey a multicast session release request to the network apparatus (200). In another embodiment, the UE (100) may release the multicast session whenever the UE (100) goes to RRC_CONNECTED state (i.e. an immediate RRC connection resume is not triggered or initiated).

In an embodiment, the multicast-inactivityTimer is stopped and/or reset and/or multicast-inactivityTimer configuration is released when the UE (100) receives RRCSetup message from the network apparatus (200) in response to a RRCReestablishmentRequest or a RRCResumeRequest or a RRCResumeRequest1 message sent by the UE (100).

### Example

The UE (100) performs the following actions upon reception of the RRCSetup:
1>if the RRCSetup is received in response RRCReestablishmentRequest; or
1>if the RRCSetup is received in response to an RRCResume Request or RRCResumeRequest1:

2>stop multicast-inactivityTimer, if running.

2>release multicast-inactivityTimer configuration

In an embodiment, the multicast-inactivityTimer is stopped and/or reset and/or multicast-inactivityTimer configuration is released when the UE (100) receives RRCResume message from the network apparatus (200) in response to RRCResumeRequest or RRCResumeRequest1 message sent by the UE (100).

In an embodiment, the UE (100) may continue to receive multicast session in the time-duration in between the events when the UE (100) initiates sending of a RRCResumeRequest or RRCResumeRequest/1 message to the network apparatus (200) and when the UE receives RRCResume or RRCSetup message from the network apparatus (200). The events mentioned are the UE (100) sending of /CResumeRequest/RRCResumeRequest1 (to initiate a RRC connection resume) and the UE (100) receiving RRCResume/RRCSetup message (response message from the network apparatus (200)). In between these two events, the UE (100) can continue to receive the multicast session. For example, the UE (100) may perform a RACH procedure on the initial UL BWP and initial DL bandwidth part (BWP) while the UE (100) receives multicast session on Active BWP, wherein the initial BWP is overlapped with Active BWP and/or UE (100) has multiple receivers to perform both together.

In an embodiment, the network apparatus (200) configures the UE (100) with the multicast-inactivityTimer per multicast session that the UE (100) is configured to receive in the RRC_INACTIVE state. The individual timers are started upon activation of the corresponding multicast session and/or when the MAC SDU or data is received for that session. The timer is started/restarted upon reception of MAC PDU for that session.

In an embodiment, the multicast-inactivityTimer is continued (i.e. timer is not stopped) and/or multicast-inactivityTimer configuration is maintained (i.e. configuration is not released) when the UE (100) receives RRCReject message from the network apparatus (200) in response to RRCResumeRequest or RRCResumeRequest1 message sent by the UE (100).

In an embodiment, when the multicast-inactivityTimer expires for the UE (100) in the RRC_INACTIVE state due to no reception of multicast packets for the activated multicast session, the UE (100) determines the deactivation of the multicast session. Further, the UE (100) indicates TMGI and/or deactivation status to the upper layers (e.g. NAS layer). The UE (100) may stop receiving for the multicast MRB and may start monitoring for group notification or group paging for the “activation” of the multicast session. The specified behaviour may be for a specific multicast session/MRB (i.e. a multicast-inactivityTimer configured per MRB) or commonly for all multicast sessions/MRBs (i.e. common multicast-inactivityTimer configured for all MRBs).

In an embodiment, when the multicast-inactivityTimer expires for the UE (100) in the RRC_INACTIVE state due to no reception of multicast packets for the activated multicast session, the UE (100) leaves the RRC_INACTIVE state and transitions to the RRC_IDLE state. Further, UE (100) may indicate TMGI and/or deactivation status to the upper layers (e.g. NAS layer). The situation may also be because of state mismatch between the UE (100) and the network apparatus (200), where the UE (100) might have missed the RRC release message for the transition to the RRC_IDLE state and remains in the RRC_INACTIVE state, while the network apparatus (200) considers the UE (100) would have been in the RRC_IDLE state.

In an embodiment, the UE (100) may transition to RRC_CONNECTED on expiry of multicast-inactivityTimer.

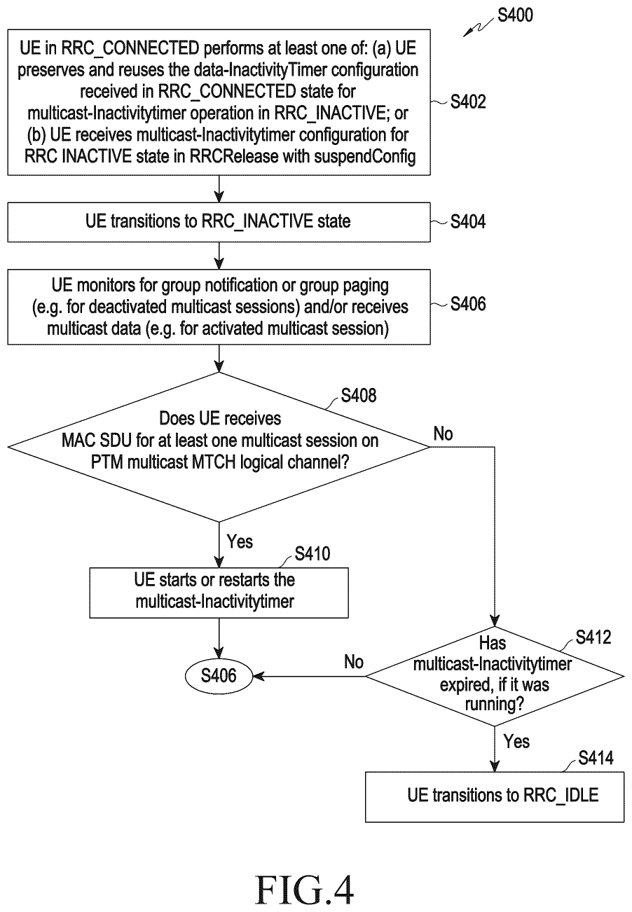

In an embodiment, when the UE (100) receives a group notification or a group paging message implicitly or explicitly indicating “activation” of the multicast session indicated by a TMGI, which the UE (100) has joined and can receive in the RRC_INACTIVE state, the UE (100) may start or restart the multicast-inactivityTimer. In an embodiment, the UE (100) may start or restart the multicast-inactivityTimer for each multicast packet received from the network apparatus (200) (e.g. a MAC SDU received on at least one MBS traffic channel (MTCH) logical channel for PTM multicast). This is illustrated in FIG. 4.

In an embodiment, when the UE (100) receives group notification or group paging message implicitly or explicitly indicating “deactivation” of the multicast session indicated by a TMGI, which the UE (100) has joined and is receiving in the RRC_INACTIVE state and if this was last activated multicast session which is now deactivated, the UE (100) may stop and reset the multicast-inactivityTimer.

In an alternate embodiment, when multicast-inactivityTimer is configured per multicast session, if the UE (100) receives a group notification or group paging message implicitly or explicitly indicating “deactivation” of the multicast session indicated by a TMGI, which the UE (100) has joined and is receiving in the RRC_INACTIVE state, the multicast-inactivityTimer associated with the multicast session is stopped. In an embodiment, the network apparatus (200) can configure the UE (100) to transition to RRC_IDLE or remain in RRC_INACTIVE state when all multicast-inactivityTimer running are stopped due to expiry or deactivation of multicast session.

In an embodiment, when the UE (100) transitions from the RRC_INACTIVE state to the RRC_CONNECTED state e.g. when doing RRC Connection Resume procedure, the UE (100) may stop (and reset) multicast-inactivityTimer, if the UE (100) is running due to reception of multicast session in the RRC_INACTIVE state.

In an embodiment, upon getting the indication from lower layer with release status of at least one relevant TMGI, upper layer requests lower layer to stop monitoring of the group paging for the relevant TMGI. If the UE (100) was in RRC_INACTIVE and the UE (100) was the last activated multicast session, which is now released, the UE (100) may stop the multicast-inactivityTimer. Further, the UE (100) may also release the multicast-inactivityTimer configuration. The UE (100) may also stop monitoring for group notification or group paging. Lastly, the UE (100) may transition to RRC_IDLE state. In an embodiment, the UE (100) may receive an indication from the network apparatus (200) either through dedicated signaling (e.g. RRC reconfiguration message or RRCRelease with suspendconfig) while being in RRC_CONNECTED or over system information block (SIB) or MCCH message on whether to transition to RRC_IDLE state on the expiry of multicast-inactivityTimer. If the indication is to transition to RRC_IDLE, the UE (100) moves to RRC_IDLE, otherwise, the UE (100) remains in RRC_INACTIVE on the expiry of multicast-inactivityTimer.

In an embodiment, if the UE (100) selects or reselects to a different cell (or a cell outside multicast session coverage area) than the cell where configuration for the multicast-inactivityTimer is received, the UE (100) stops and/or resets and/or releases the configuration for the multicast-inactivityTimer.

In an embodiment, if the UE (100) reselects outside the RAN Notification Area (RNA), the UE (100) stops and/or resets and/or releases the configuration for the multicast-inactivityTimer. If the reselection is within the RNA, the UE (100) may keep the configuration.

FIG. 2 shows various hardware components of the UE (100), according to the embodiments as disclosed herein. In an embodiment, the UE (100) includes a processor (110), a communicator (120), a memory (130) and a UE inactivity controller (140). The processor (110) is coupled with the communicator (120), the memory (130) and the UE inactivity controller (140).

The UE inactivity controller (140) receives the multicast-inactivity timer configuration by the network apparatus (200) when the UE (100) is in the RRC connected state. The multicast-inactivity timer configuration is received in one of the RRC Reconfiguration message, the RRC Release with suspend configuration message, and the SIB message or the MCCH message. The multicast-inactivity timer configuration is at least one of the pre-specified, the pre-configured and the part of reduced configuration that is applicable to the UE (100) for the multicast reception in the RRC inactive state.

Further, the UE inactivity controller (140) detects that the UE (100) is transitioned from the RRC connected state to the RRC inactive state. Based on the multicast-inactivity timer configuration, the UE inactivity controller (140) monitors whether the UE (100) receives in the RRC inactive state at least one of the multicast data and the group notification or the group paging message indicating “activation” or “deactivation” of the multicast session. The multicast data corresponds to the MAC SDU for at least one multicast session on a PTM MTCH logical channel.

In an embodiment, the UE inactivity controller (140) determines whether the multicast data is received by the UE (100) based on the multicast-inactivity timer in the RRC inactive state configuration by storing the data-Inactivity timer configuration while transitioning from the RRC connected state to the RRC inactive state or the RRC idle state when the UE (100) is configured to receive or continue receiving the multicast data in the RRC inactive state, and reusing the data-Inactivity timer configuration of the RRC connected state for the multicast-inactivity timer configuration to be used for the multicast UE (100) to receive the multicast data in the RRC inactive state.

In an embodiment, the UE inactivity controller (140) starts the multicast-inactivity timer or restarts the multicast-inactivity timer in the RRC inactive state when the UE (100) receives at least one of the multicast data and the group notification or the group paging message indicating “activation”of the multicast session.

In another embodiment, the UE inactivity controller (140) stops the multicast-inactivity timer or resets a multicast-inactivity timer in the RRC inactive state when the UE (100) receives at least one of the group notification or the group paging message indicating “deactivation”of the multicast session.

In another embodiment, the UE inactivity controller (140) transitions the UE (100) from the RRC inactive state to the RRC idle state when the UE (100) does not receive at least one of the multicast data, the group notification, and the group paging message.

In an embodiment, the UE inactivity controller (140) detects that the multicast-inactivity timer is running. Further, the UE inactivity controller (140) determines whether the multicast-inactivity timer is expired. The UE inactivity controller (140) sends the indication from the lower layer of the UE (100) to the upper layer of the UE (100) indicating expiry of the multicast-inactivity timer, and transitions the UE (100) from the RRC inactive state to the RRC idle state when the multicast-inactivity timer is expired. Alternatively, the UE inactivity controller (140) continue monitors whether the multicast data is received by the UE (100) in the RRC inactive state.

In another embodiment, the UE (100) transitions from the RRC inactive state to the RRC idle state when no activated multicast MBS radio bearer (MRB) configuration is available for the UE (100).

Upon receiving the indication, the UE inactivity controller (140) sends the request from the upper layer to the lower layer to stop monitoring of the group notification or the group paging message. Further, the UE inactivity controller (140) stops the multicast-inactivity timer and releases the multicast-inactivity timer configuration.

In another embodiment, the UE inactivity controller (140) receives the indication from the network apparatus (200) when the UE (100) is in the RRC inactive state thorough at least one of the dedicated signaling message, the SIB message or the MCCH message. the UE inactivity controller (140) transitions the UE (100) from the RRC inactive state to the RRC idle state when the indication is to transition to the RRC idle state on expiry of the multicast-inactivity timer. Alternatively, the UE inactivity controller (140) transitions the UE (100) from the RRC inactive state to the RRC connected state when the indication is to transition to the RRC connected state on expiry of the multicast-inactivity timer. Alternatively, the UE inactivity controller (140) maintains the UE (100) in the RRC inactive state when the indication is to continue to stay in the RRC inactive state on expiry of the multicast-inactivity timer.

In another embodiment, the UE inactivity controller (140) transitions the UE (100) from the RRC inactive state to the RRC connected state upon expiry of the multicast-inactivity timer.

In another embodiment, the UE inactivity controller (140) triggers the initiation of the RRC connection resume upon validating congestion status of the network apparatus (200) using the broadcast signalling message.

In an embodiment, the UE inactivity controller (140) further determines the connection loss while receiving the multicast data in the RRC inactive state. Further, the UE inactivity controller (140) sends the RRC connection resume request to the network apparatus (200). Further, the UE inactivity controller (140) sends the multicast session release request to the network apparatus (200).

In an embodiment, the UE inactivity controller (140) further determines the loss of interest in receiving the multicast session in the RRC inactive state. Further, the UE inactivity controller (140) sends the RRC connection resume request to the network apparatus (200). Further, the UE inactivity controller (140) sends a multicast session release request to the network apparatus (200).

In an embodiment, the UE inactivity controller (140) further receives one of the RRCSetup message and the RRCResume message from the network apparatus (200) in response to one of the RRCReestablishmentRequest or the RRCResumeRequest or the RRCResumeRequest1 message sent by the UE (100). Further, the UE inactivity controller (140) performs at least one of: stops or resets the multicast-inactivityTimer, and releases the multicast-inactivityTimer configuration.

In an embodiment, the UE inactivity controller (140) receives the RRCReject message from the network apparatus (200) in response to one of the RRCResumeRequest or the RRCResumeRequest1 message sent by the UE (100). Further, the UE inactivity controller (140) performs at least one of: continues the multicast-inactivityTimer, and maintains the multicast-inactivityTimer configuration.

In an embodiment, the UE inactivity controller (140) further continues to receive the multicast session in time-duration in between events when the UE (100) initiates sending of the RRCResumeRequest or RRCResumeRequest1 message to the network apparatus (200) when the UE (100) receives one of the RRCResume or the RRCSetup message from the network apparatus (200).

The UE inactivity controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

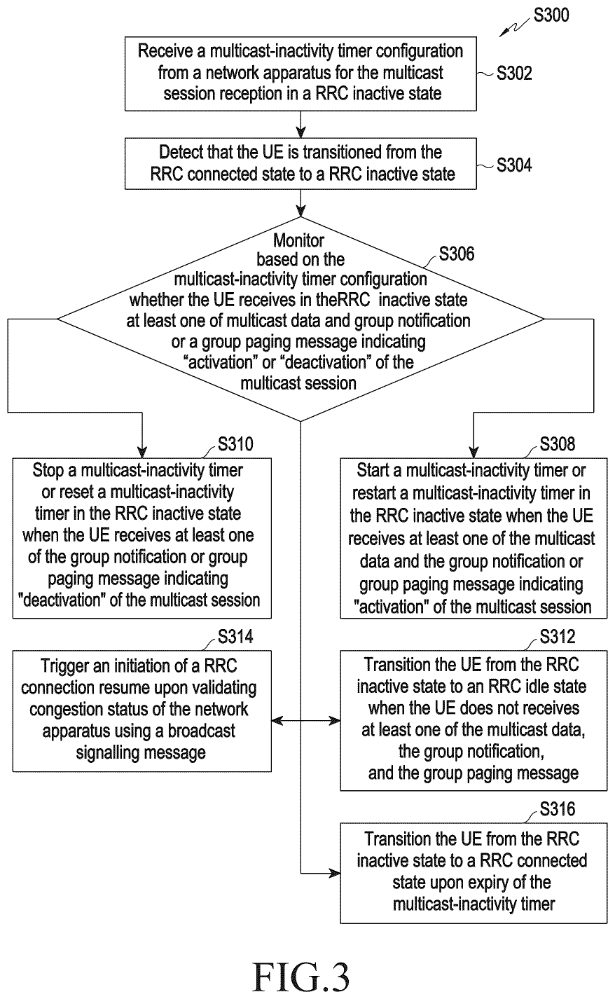

FIG. 3 is a flow chart (S300) illustrating a method for managing the inactivity for the UE (100) for the NR-MBS in the wireless network (1000), according to the embodiments as disclosed herein. The operations (S302-S316) are handled by the UE inactivity controller (140).

At step S302, the method includes receiving the multicast-inactivity timer configuration from the network apparatus (200) for the multicast session reception in the RRC inactive state. At step S304, the method includes detecting that the UE (100) is transitioned from the RRC connected state to the RRC inactive state. At step S306, the method includes monitoring based on the multicast-inactivity timer configuration whether the UE (100) receives in the RRC inactive state at least one of the multicast data and the group notification or the group paging message indicating “activation” or “deactivation”of the multicast session.

Further, the UE (100) may take at least one of the following operations (S308-S316) after performing the operation (i.e., S306). At step S308, the method includes starting the multicast-inactivity timer or restarting the multicast-inactivity timer in the RRC inactive state when the UE (100) receives at least one of the multicast data and the group notification or the group paging message indicating “activation” of the multicast session. At step S310, the method includes stopping the multicast-inactivity timer or resetting the multicast-inactivity timer in the RRC inactive state when the UE (100) receives at least one of the group notification or the group paging message indicating “deactivation” of the multicast session. At step S312, the method includes transitioning the UE (100) from the RRC inactive state to the RRC idle state when the UE (100) does not receive at least one of the multicast data, the group notification, and the group paging message. At step S314, the method includes triggering the initiation of the RRC connection resume upon validating congestion status of the network apparatus (200) using the broadcast signalling message. At step S316, the method includes transitioning the UE (100) from the RRC inactive state to the RRC connected state upon expiry of the multicast-inactivity timer.

The method can be used for configuring and operating the multicast inactivity timer for the UEs configured and/or capable of receiving multicast sessions in the RRC_INACTIVE state and/or receiving multicast sessions in the RRC_INACTIVE state, so as to ensure reliable and efficient multicast reception performance.

FIG. 4 illustrates an example flow chart (S400) to configuring and operating a multicast inactivity timer for the multicast UEs (100) configured and/or capable of receiving multicast sessions in the RRC_INACTIVE state and/or receiving multicast sessions in the RRC_INACTIVE state, according to the embodiments as disclosed herein.

At step 402, the UE (100) in the RRC_CONNECTED performs at least one of: the UE (100) preserves and reuses the data-InactivityTimer configuration received in the RRC_CONNECTED for the multicast-Inactivitytimer operation in the RRC_INACTIVE state, or the UE (100) receives the multicast-Inactivitytimer configuration for the RRC_INACTIVE state in the RRCRelease with suspendConfig. At step 404, the UE (100) transitions to the RRC_INACTIVE state. At step 406, the UE (100) monitors for the group notification or the group paging (e.g. for deactivated multicast sessions and/or for activated multicast sessions) and/or receives the multicast data (e.g. for activated multicast session).

At step 408, the UE (100) determines whether the UE (100) receives MAC SDU for at least one multicast session on the PTM multicast MTCH logical channel. Upon determining that the UE (100) receives the MAC SDU for at least one multicast session on the PTM multicast MTCH logical channel then, at step 410, the UE (100) starts or restarts the multicast-Inactivitytimer. Upon determining that the UE (100) does not receive the MAC SDU for at least one multicast session on the PTM multicast MTCH logical channel then, at step 412, the UE (100) determines that whether the multicast-Inactivitytimer is expired, if the multicast-Inactivitytimer was running. Upon determining that the multicast-Inactivitytimer is expired then, at step 414, the UE (100) transitions to the RRC_IDLE state. Upon determining that the multicast-Inactivitytimer is not expired then, at step 406, the UE (100) monitors for the group notification or the group paging (e.g. for deactivated multicast sessions and/or for activated multicast sessions) and/or receives the multicast data (e.g. for activated multicast session).

The various actions, acts, blocks, steps, or the like in the flow charts (S300 and S400) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method for managing inactivity by a user equipment (UE) (100) for new radio multicast broadcast service (NR-MBS) in a wireless network (1000), comprising:
receiving, by the UE (100) from a network apparatus (200), a multicast-inactivity timer configuration for a multicast session reception in a radio resource control (RRC) inactive state;
identifying, by the UE (100), that the UE (100) is transitioned from a RRC connected state to the RRC inactive state; and
monitoring, by the UE (100), based on the multicast-inactivity timer configuration whether the UE (100) receives in the RRC inactive state at least one of multicast data and a group notification or a group paging message indicating “activation” or “deactivation” of the multicast session.

2. The method as claimed in claim 1, further comprising:
performing, by the UE (100), at least one of:
starting a multicast-inactivity timer or restarting a multicast-inactivity timer in the RRC inactive state when the UE (100) receives at least one of the multicast data and the group notification or the group paging message indicating “activation” of the multicast session,
stopping a multicast-inactivity timer or resetting a multicast-inactivity timer in the RRC inactive state when the UE (100) receives at least one of the group notification or the group paging message indicating “deactivation” of the multicast session,
transitioning the UE (100) from the RRC inactive state to an RRC idle state when the UE (100) does not receive at least one of the multicast data, the group notification, and the group paging message,
transitioning the UE (100) from the RRC inactive state to a RRC connected state upon expiry of the multicast-inactivity timer, and triggering an initiation of a RRC connection resume upon validating congestion status of the network apparatus (200) using a broadcast signalling message.

3. The method as claimed in claim 2, wherein transitioning the UE (100) from the RRC inactive state to the RRC idle state comprises:
detecting, by the UE (100), that the multicast-inactivity timer is running;
determining, by the UE (100), whether the multicast-inactivity timer is expired; and
performing, by the UE (100), one of:
sending an indication from a lower layer of the UE (100) to an upper layer of the UE (100) indicating expiry of the multicast-inactivity timer, and transitioning the UE (100) from the RRC inactive state to the RRC idle state when the multicast-inactivity timer is expired, and
continue monitoring by the UE (100) whether the multicast data is received by the UE (100) in the RRC inactive state.

4. The method as claimed in claim 3, wherein the UE (100) transitions from the RRC inactive state to the RRC idle state when no activated multicast MBS radio bearer (MRB) configuration is available for the UE (100).

5. The method as claimed in claim 3, wherein, upon receiving the indication, the method comprises:
sending by the UE (100), a request from the upper layer to the lower layer to stop monitoring of the group notification or group paging message;
stopping, by the UE (100), the multicast-inactivity timer; and
releasing, by the UE (100), the multicast-inactivity timer configuration.

6. The method as claimed in claim 2, wherein transitioning the UE (100) from the RRC inactive state to the RRC idle state comprises:
receiving, by the UE (100), an indication from the network apparatus (200) when the UE (100) is in the RRC inactive state thorough at least one of a dedicated signaling message, a system information block (SIB) message or a MCCH message; and
performing, by the UE (100), at least one of:
transitioning the UE (100) from the RRC inactive state to the RRC idle state when the indication is to transition to the RRC idle state on expiry of the multicast-inactivity timer;
transitioning the UE (100) from the RRC inactive state to the RRC connected state when the indication is to transition to the RRC connected state on expiry of the multicast-inactivity timer; and
maintaining the UE (100) in the RRC inactive state when the indication is to continue to stay in the RRC inactive state on expiry of the multicast-inactivity timer.

7. The method as claimed in claim 1, wherein determining, by the UE (100), whether multicast data is received by the UE (100) based on the multicast-inactivity timer in the RRC inactive state configuration comprises:
storing, by the UE (100), a data-Inactivity timer configuration while transitioning from the RRC connected state to the RRC inactive state or the RRC idle state when the UE (100) is configured to receive or continue receiving the multicast data in the RRC inactive state; and
reusing by the UE (100) the data-Inactivity timer configuration of the RRC connected state for the multicast-inactivity timer configuration to be used for the multicast UE (100) to receive the multicast data in the RRC inactive state.

8. The method as claimed in claim 1, wherein the method comprises:
determining, by the UE (100), a connection loss while receiving the multicast data in the RRC inactive state;
sending, by the UE (100), a RRC connection resume request to the network apparatus (200); and
sending, by the UE (100), a multicast session release request to the network apparatus (200).

9. The method as claimed in claim 1, wherein the method comprises:
determining, by the UE (100), a loss of interest in receiving the multicast session in the RRC inactive state;
sending, by the UE (100), a RRC connection resume request to the network apparatus (200); and
sending, by the UE (100), a multicast session release request to the network apparatus (200).

10. The method as claimed in claim 1, wherein the multicast-inactivity timer configuration is received in one of a RRC Reconfiguration message, a RRC Release with suspend configuration message, and a System Information Block (SIB) message or MBS control Channel (MCCH) message, and
wherein the multicast-inactivity timer configuration is at least one of pre-specified, pre-configured and a part of reduced configuration that is applicable to the UE (100) for multicast reception in the inactive state, and
wherein the multicast-inactivity timer is started or restarted for each multicast packet of the multicast data received from the network apparatus (200).

11. The method as claimed in claim 1, wherein the multicast data corresponds to a MAC SDU for at least one multicast session on PTM multicast MBS traffic channel (MTCH) logical channel.

12. The method as claimed in claim 1, wherein the method comprises:
receiving, by the UE (100), one of a RRCSetup message and a RRCResume message from the network apparatus (200) in response to one of a RRCReestablishmentRequest or a RRCResumeRequest or a RRCResumeRequest1 message sent by the UE (100); and
performing, by the UE (100), at least one of:
stopping or resetting the multicast-inactivityTimer, and releasing a multicast-inactivityTimer configuration.

13. The method as claimed in claim 1, wherein the method comprises:
receiving, by the UE (100), a RRCReject message from the network apparatus (200) in response to one of a RRCResumeRequest or a RRCResumeRequest1 message sent by the UE (100); and
performing, by the UE (100), at least one of:
continuing the multicast-inactivityTimer, and
maintaining the multicast-inactivityTimer configuration.

14. The method as claimed in claim 1, wherein the UE (100) continues to receive the multicast session in time-duration in between events when the UE (100) initiates sending of a RRCResumeRequest or RRCResumeRequest1 message to the network apparatus (200) when the UE (100) receives one of RRCResume or RRCSetup message from the network apparatus (200).

15. A user equipment (UE) (100) for managing inactivity for new radio multicast broadcast service (NR-MBS) in a wireless network (1000), wherein the UE (100) comprises:
a transceiver (120); and
a controller (140), coupled to the transceiver (120) and configured to control to:
receive a multicast-inactivity timer configuration by a network apparatus (200) for a multicast session reception is in a RRC inactive state;
identify that the UE (100) is transitioned from the RRC connected state to a RRC inactive state; and
monitor based on the multicast-inactivity timer configuration whether the UE (100) receives in the RRC inactive state at least one of multicast data and a group notification or a group paging message indicating “activation” or “deactivation” of the multicast session.
